(19) United States
(12) Patent Application Publication
(10) Pub. No.: US 2022/0108638 A1
(43) Pub. Date: Apr. 7, 2022

(54) LED MODULE POSITIONING SYSTEM

(71) Applicant: PLANAR SYSTEMS, INC., HILLSBORO, OR (US)

(72) Inventors: Eric Schuettke, Tualatin, OR (US); Matt Smith, Hillsboro, OR (US); Neil Brashnyk, Portland, OR (US)

(21) Appl. No.: 17/449,793

(22) Filed: Oct. 1, 2021

Related U.S. Application Data
(60) Provisional application No. 63/087,016, filed on Oct. 2, 2020.

(51) Int. Cl. G09F 9/302; F16M 13/02; G09F 9/33

(52) U.S. Cl. CPC G09F 9/3026; G09F 9/33; F16M 13/02

(57) ABSTRACT

A system for mounting and positioning an array of panels, such as display modules of an electronic display device, includes a plurality of springs supported on a chassis that includes an array of cavities bordered by multiple ribs. Each of the panels is supported on front surfaces of the ribs to establish a Z position of the panel. Each panel is engaged by one or more of the springs to press together abutting edges of adjacent panels, which may reduce the appearance of seams between adjacent pairs of panels and accommodate thermal expansion. Magnetic elements retain each panel to the chassis in the Z direction while allowing the panels to float on the springs in the X and Y directions. Magnetically-actuated retention hooks allow the panels to be removed from the chassis without accessing a rear of the system.

### RELATED APPLICATION

This application claims the benefit under 35 U.S.C. § 119(e) of U.S. Provisional Patent Application No. 63/087,016, filed Oct. 2, 2020, which is incorporated herein by reference.

### TECHNICAL FIELD

This disclosure relates to positioning systems for arrays of electronic image display modules or other panels, and, in particular, a positioning system comprising springs that maintain the position and relative alignment of individual display modules or panels in the array.

### BACKGROUND

Known display module positioning systems often assemble multiple display modules into an array, forming a larger display, where a video or image is displayed across the multiple modules. Uniformity of video or images displayed across multiple modules requires alignment of the modules with specified dimensional accuracy such that positional variations between modules are reduced. If adjacent modules are not aligned correctly with each other, lines or “seams” between the modules may be more visible, which is undesirable.

Unlike liquid crystal displays (LCDs), where display power use is generally constant, power use in a direct-view light-emitting diode (DV-LED) display is adjusted on a pixel-by-pixel basis according on the content of video or images being displayed. This variation in power can cause thermal expansion of modules, which can in turn create module misalignment, impacting display uniformity. Known positioning systems often affix modules to a rigid support structure such that they are clamped in position. However, such systems may cause modules to bow or otherwise bend when thermal expansion occurs, and may also require access to the rear of the display for module removal, which can make replacing modules cumbersome and time intensive.

The present inventors have recognized these and other shortcomings of prior art display module positioning systems, and a need for improved systems. Thus, the present inventors have recognized that DV-LED displays require a positioning system for display modules that maintain relative position between modules when thermal expansion occurs and provide access to remove modules from the front of the display for servicing, repair, or replacement.

### SUMMARY

The positioning system disclosed herein is designed to maintain alignment of display modules or other panel structures while compensating for thermal expansion or other stresses and/or or forces within the system, thereby minimizing the visibility of seams between modules or other panels. For example, the system may include chassis that supports adjacent display modules using one or more springs, where the springs have a preload force applied to them that reduces movement and misalignment of modules caused by thermal expansion. The system may realize an additional advantage of achieving a front-access-only installation without requiring access to the rear, top, bottom, or sides of the display system.

Additional aspects and advantages will be apparent from the following detailed description of preferred embodiments, which proceeds with reference to the accompanying drawings.

### BRIEF DESCRIPTION OF THE DRAWINGS

FIG. 1 is an isometric view of a display device including an array of display modules positioned via a positioning system according to an embodiment.

FIG. 2. is an exploded assembly detail view of a section of the display device of FIG. 1, with a display module and other components of the display device exploded to show detail of the assembly.

FIG. 3 is a front elevation view of the portion of the positioning system of FIG. 2 with the display module removed.

FIG. 4 is a partially exploded isometric detail view of a section of the display device of FIG. 1, showing the back side of a display module and details of its connection to the positioning system.

FIGS. 5-7 are cross sectional views taken along line 5-5 of FIG. 4, illustrating stages of the installation of two adjacent display modules into the positioning system, and the various forces applied to the installed display modules.

FIG. 8 is an isometric view of a display device with including an array of chassis forming an enlarged positioning system according to another embodiment, with display modules removed.

FIG. 9 is a front elevation view of the positioning system of FIG. 8.

FIG. 10 is a back elevation view of the positioning system of FIG. 8.

FIG. 11 is a cross sectional view along line 11-11 of FIG. 9, illustrating two adjacent chassis of the positioning system of FIG. 8

### DETAILED DESCRIPTION OF PREFERRED EMBODIMENTS

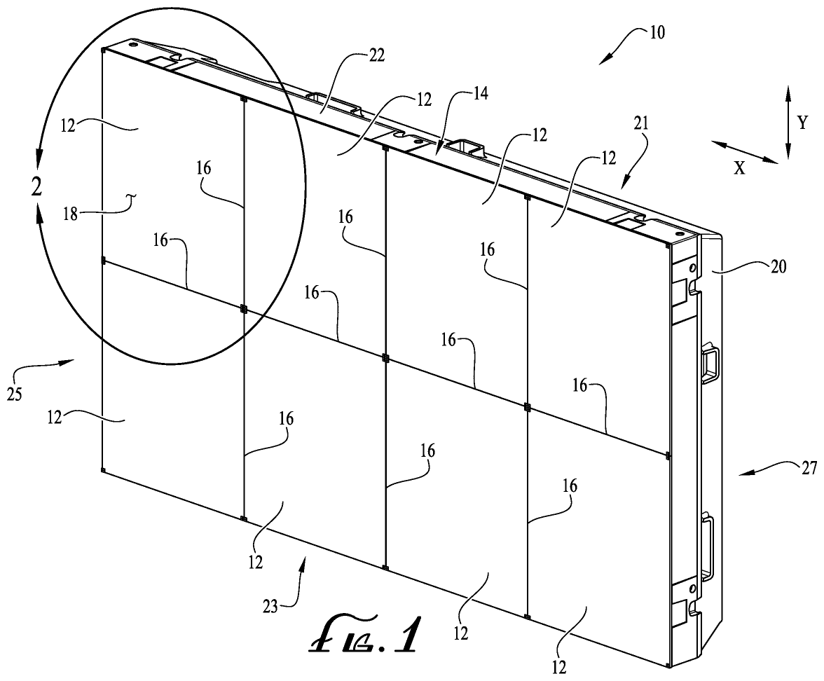

FIG. 1 shows an isometric front view of an electronic display device 10 comprising an array of display modules 12. In the embodiment shown, electronic display device 10 is a DV-LED display and each module 12 is secured to a chassis 14 such that a visible seam 16 between adjacent pairs of modules 12 is inhibited or minimized. Chassis 14 may constitute a rigid frame on which display modules 12 are installed, and is preferably formed of unitary one-piece construction of aluminum or another metal or rigid material.

Each module 12 includes a panel, and the array of panels forming a forward-facing display surface 18 that extends in X and Y directions in a Cartesian coordinate system. (Note: References herein to X, Y, and Z directions and X, Y, and Z dimensions refer to directions and dimensions in a Cartesian coordinate system and a frame of reference illustrated by orthogonal X, Y and Z axes in the Figures.) In the embodiment shown, the rear of electronic display device 10 is covered by a back cover 20 attached to an opposite side of chassis 14 from display surface 18. In the embodiment shown, each display module 12 has the same shape. In other embodiments (not shown), display modules 12 each have different shapes. In other embodiments, one or more display modules 12 have one shape, and one or more other display modules 12 have another shape. For example, the panel of display module 12 may be rectangular (as shown in FIG. 1), triangular, pentagonal, hexagonal, octagonal, or have any other regular or irregular polygon shape. In the embodiment shown, the panel of each module 12 includes a single display tile. In other embodiments (not shown), the panel of each module may be formed by a set or array of multiple tiles, such as 2, 4, 6, 8, 12, or 16 tiles, or any other number, for example. Each set of tiles forming the panel of a module may be arranged in a rectangular array, for example, but alternatively the arrangement or array of each collection of tiles is dictated by the shape of the tiles.

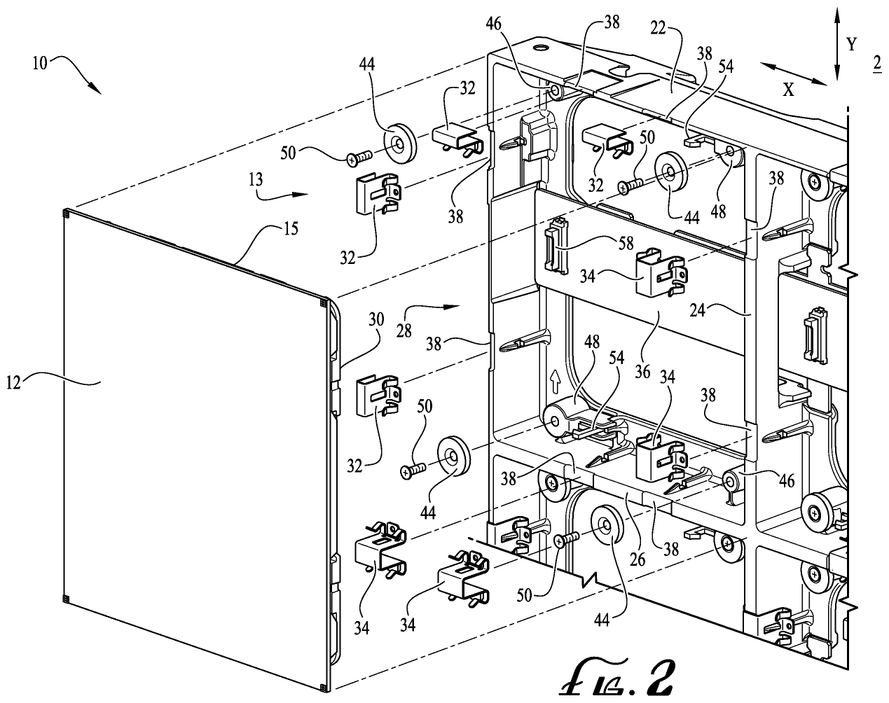

FIG. 2. is an exploded detail view of display device 10, showing how display module 12 is installed in display device 10 using a positioning system 13 of display device 10. Positioning system 13 includes chassis 14 having one or more springs 32 and/or 34, one or more magnetic elements 44, and a retention hook 54, and secures and positions a module 12 in display device 10, as further described below. While the embodiment shown uses springs 32 and 34, other force generating mechanisms (e.g., magnetic elements) may be used instead to implement the functionality of spring 32 and/or spring 34. In the embodiment shown, display module 12 is installed at least partly in a cavity 28 of chassis 14. With reference to FIGS. 1-4, each cavity 28 of chassis 14 has X, Y, and Z dimensions that are the same as the respective X, Y and Z dimensions of other cavities 28. In other embodiments, one or more cavities 28 have different X, Y, and/or Z dimensions to one or more other cavities 28 of chassis 14. For example, one or more cavities 28 located in and/or around a certain region of chassis 14 may have smaller or larger X, Y, and/or Z dimensions compared to one or more cavities 28 in other regions of chassis 14. In one example, one or more cavities 28 located in and/or around a central region of chassis 14 may have smaller X, Y, and/or Z dimensions compared to one or more cavities 28 in the surrounding region and/or a perimeter region of chassis 14.

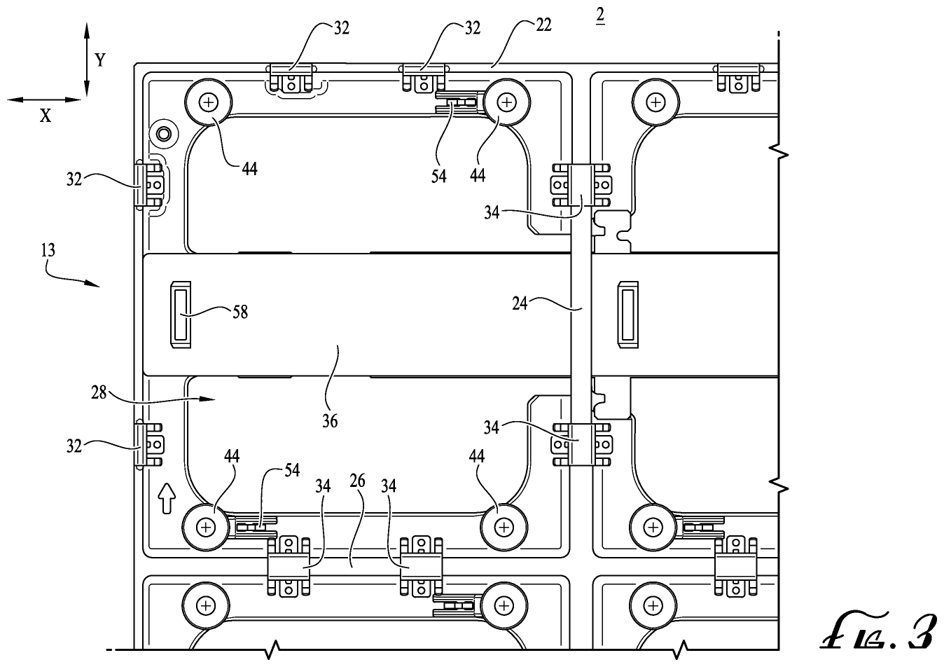

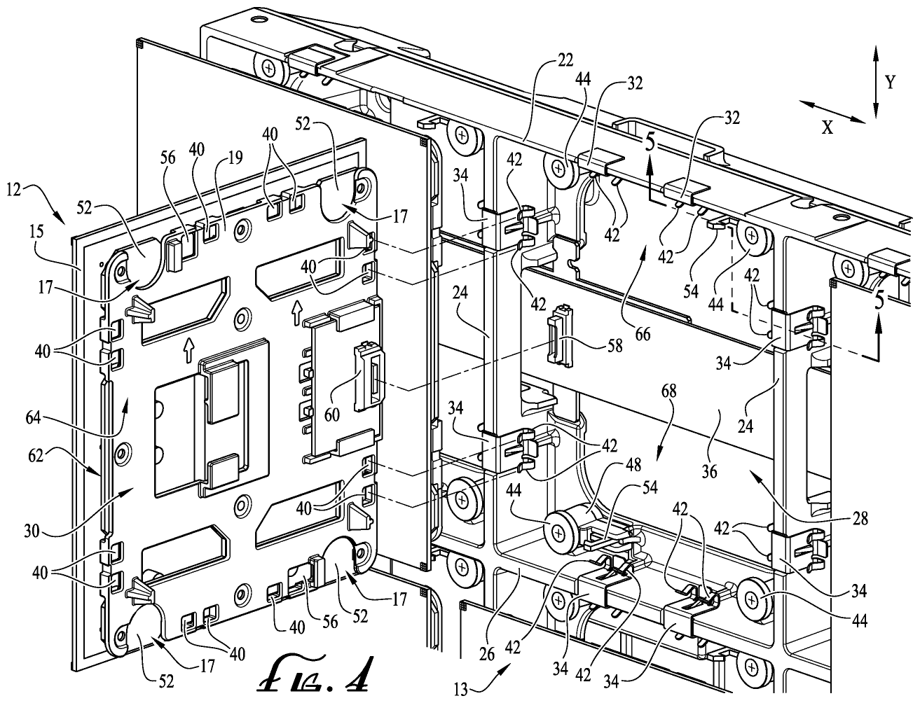

With reference to FIG. 2, chassis 14 includes a perimeter frame 22, as well as vertical and horizontal ribs 24 and 26 crisscrossing the perimeter frame 22 and dividing the chassis 14 into sections. The members of the perimeter frame 22 and ribs 24, 26 are also referred to herein as frame and rib members 22, 24, 26. The frame and rib members 22, 24, 26 border and define lateral boundaries of an array of cavities 28 of the chassis 14. FIG. 3 is a front detail view of chassis 14 with display module 12 removed. FIG. 4 is a partially exploded detail view showing the back side of a module 12 to be installed in one of the cavities 28 of display device 10 and secured by chassis 14. To show additional detail of positioning system 13, the module 12 shown exploded in FIG. 4 is a different one of the modules 12 than shown in FIG. 2. With reference to FIGS. 2-4, in the embodiment shown, each module 12 includes a base plate 30 attached to a back side of a circuit board or display tile 15, or collection of tiles, that carries the many discrete LEDs of the DV-LED display. (Note: For clarity and simplicity, only a few of the discrete LEDs are illustrated in the Figures, at the corners of the display tiles 15.) Base plate 30 facilitates attachment of module 12 to chassis 14 via positioning system 13. In the embodiment shown, base plate 30 is formed by a magnetic element 52 plate layer and another layer 19. For example, layer 19 may be an injection molded plastic layer.

In the embodiment shown, positioning system 13 includes a plurality of springs 32, 34 supported by chassis 14 and disposed behind (rearward of) display surface 18. In particular, positioning system 13 may include one or more single-sided springs 32 attached to vertical and horizontal portions of perimeter frame 22 of chassis 14, and one or more double-sided springs 34 attached to and straddling vertical and horizontal ribs 24 and 26 of chassis 14. In the embodiment shown, springs 32 and 34 are attached to the chassis 14 by resting grooves 38 formed in the frame and rib members 22, 24, 26 such that a front surface of each spring 32, 34 faces in the same direction as display surface 18 and is substantially flush with, or slightly recessed below, the front-facing surface or edge of the respective frame or rib member 22, 24, or 26 to which it is mounted. In other embodiments, one or more of springs 32 and 34 are attached to frame or rib members 22, 24, or 26 without the use of grooves 38, and are attached using a fastener or otherwise clipping or straddling onto the front edge of the member. In other embodiments, two single-sided springs 32, aligned substantially back-to-back or adjacent along the front edge of vertical rib 24 and/or horizontal rib 26 may be used rather than a double-sided spring 34 to provide the same or similar effect.

With particular reference to FIG. 4, springs 32 and 34 are configured to bear against the respective perimeter frame 22 or rib 24 or 26 and to engage respective openings 40 of a base plate 30 of a module 12, thereby aligning the module 12 with adjacent modules and securing module 12 to chassis 14. In particular, springs 32 and 34 each include one or more legs 42 configured to be inserted into and received by one of the openings 40, and to engage an inner surface bordering the opening to thereby be deflected away from the frame or rib member (22, 24, 26) to which the spring is mounted. The deflection of springs 32 and 34 by their insertion in openings 40 imparts forces on the module 12 in the X and/or Y directions. In the embodiment shown, each spring 32 comprises two legs 42, and each spring 34 comprises four legs 42 (two extending into each of the cavities 28 adjacent the rib 24 to which the spring 34 is attached). However, in other embodiments, springs 32 and 34 can have one, three, four, or any number of legs 42. In the embodiment shown, legs 42 have a curved and recurved shape, as shown in FIGS. 2-7. However, in other embodiments, legs 42 may have any other shape. For example, legs 42 may include ninety (or thereabout) degree corners and/or straightened legs lacking curvature.

Regarding spring 32 located on the perimeter frame 22 of chassis 14, after engaging base plate 30, the legs 42 of each spring 32 flex back toward their resting position to an engaged position (that is slightly flexed relative to their resting position) so as to apply a preload force to the module 12 in the X or Y direction, securing the base plate 30 to the chassis 14.

With reference again to FIGS. 2-4, in the embodiment shown, four magnetic elements 44 are each attached to a respective magnet mount 46 or 48 via a fastener 50, such as a threaded fastener or screw. Each magnetic element 44 is designed to interact magnetically with magnetic element 52 (shown in FIG. 4) of base plate 30 to help secure and retain module 12 to chassis 14 with magnetic attraction. In the embodiment shown, chassis 14 includes four magnetic elements 44 for each module 12 and base plate 30 includes a plate of magnetic material that forms magnetic element 52, where openings 17 of layer 19 exposes magnetic element 52. In other embodiments, magnetic elements 44 and/or 52 may be formed by any number of elements, such as only one, two, three, four five, six, seven, eight, nine, ten, or any other larger number of magnetic elements. In the embodiment shown, for cavity 28 of chassis 14, four magnetic elements 44 are each set spaced apart from another and aligned therewith for accommodating a module 12. Alternatively, the present disclosure contemplates other arrangements of magnetic elements to support each module 12, where the same or different numbers of magnetic elements are used to support each module. For example, one module 12 may be supported by four magnetic elements 44 of chassis 14 and four magnetic elements 52 of base plate 30, but another module 12 may be supported by six magnetic elements 44 of chassis 14 and six magnetic elements 52 of base plate 30.

In some embodiments, magnetic elements 44 and 52 are permanent magnets. For example, magnetic elements 44 and 52 may be steel-encased permanent magnets (also known as a “pot magnet”) which focuses the magnetic field and shunts the magnetic flux when an air gap is formed between the pot magnet and another magnetic element. Alternatively, magnetic elements 44 and 52 may include electromagnets. In some embodiments, a first set of magnetic elements (e.g., set formed by magnetic elements 44) is formed by permanent magnets or electromagnets, while the other set of magnetic elements (e.g., set formed by magnetic elements 52) is formed by a magnetic material such as steel, which is attracted to the permanent magnets of the first set. In some embodiments the magnetic elements may be integrally part of the base plate 30 or chassis 14. For example, the chassis 14 could be made of a magnetic material such as steel.

FIGS. 2-4 further show retention hooks 54 of chassis 14, which prevent display modules 12 from being accidentally removed or detached from the chassis 14 or from accidentally falling from the chassis 14. In the embodiment shown, each retention hook 54 is rotationally coupled to each magnet mount 48 and configured to hook through an opening 56 (shown in FIG. 4) of base plate 30, securing module 12 to chassis 14 by retaining the plate 30 and preventing plate 30 from being detached from chassis 14, for example in the event that magnetic attraction between magnetic elements 52, 44 of the module 12 and chassis 14 is overcome by external force on the module 12. In the embodiment shown one retention hook 54 is positioned in an upper region 66 of a cavity 28, and another retention hook 54 is positioned in a lower region 68 of cavity 28. For example, in the event that one or more magnetic elements 44 become misaligned with one or more magnetic elements 52 of base plate 30, compromising magnetic coupling between display module 12 and chassis 14, and/or base plate 30 is not secured by one or more of springs 32 and/or 34, retention hook 54 maintains attachment of display module 12 to chassis 14. To allow the modules 12 to float in the X and Y directions, the retention hooks 54 preferably do not contact modules 12 or otherwise provide active retention force when the modules 12 are properly in position on chassis 14. Chassis 14 further includes an electrical port 58 positioned on a support 36, configured for electrical coupling to an electrical port 60 (shown in FIG. 4) of each module 12, either directly or optionally indirectly via interconnecting electrical connectors and cabling, whereby electrical power and image or video data for display by a module 12 is transmitted to each module 12 via ports 58 and 60.

Turning to FIG. 4, base plate 30 attached to module 12 and has a front side 62 facing display tile 15 and a back side 64 facing away from display tile 15. In the embodiment shown, back side 64 includes magnetic elements 52 that lie in a common plane and cooperate with magnetic elements 44 of chassis 14 to magnetically attract base plate 30 toward chassis 14 in the Z direction. In other embodiments, magnetic elements 52 lie in different planes of plate 30, and are attracted to magnetic elements 44 that are respectively offset or otherwise positioned on chassis 14 such that base plate 30 is mounted to chassis 14.

By mounting base plate 30 to the positioning system formed by chassis 14, springs 32 and 34, and magnetic elements 44, the display module 12 is flexibly secured such that thermal expansion of module 12 does not cause misalignment of module 12 in relation to adjacent modules 12. As discussed above, springs 32 and 34 are biased such that they produce a force against base plate 30 in the X or Y direction along the plane of the display surface 18, biasing each module 12 toward its adjacent module or modules, which inhibits the opening of seams 16 (FIG. 1) between adjacent pairs of modules 12 and accommodates changes in the shape or size of modules 12 due to thermal expansion. For example, in the event of thermal expansion due to variations in power delivered to a module 12, the resiliency of springs 32 and/or 34 maintains the positional biasing of module 12 toward adjacent modules, inhibiting or minimizing seams 16. Springs 32 and/or 34 act in concert to keep display modules aligned and relatively positioned, producing forces that counter those that result from thermal expansion. Accordingly, gaps between adjacent modules 12 that would otherwise disrupt the LED pitch across an array of modules are reduced or eliminated.

The coupling of base plate 30 to chassis 14 via positioning system 13 further allows for removing a display module 12 from the front of display device 10 rather than the rear. In the embodiment shown, each spring 32 and 34 can be disengaged from base plate 30 by pulling module 12 away from chassis 14, flexing one or more legs 42 (shown in FIGS. 3 and 4) away from the frame or rib member (22, 24, 26) where the spring is installed. Further, such movement of module 12 away from chassis 14 provides de-coupling of magnetic elements 44 and 52 with each other, and retention hook 54 from opening 56 of base plate 30.

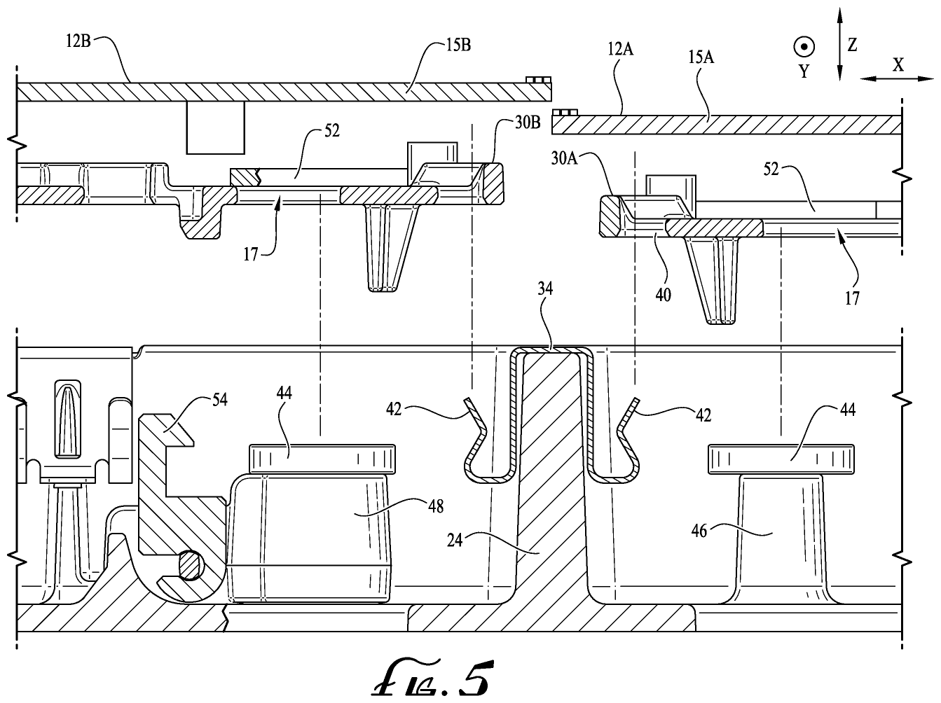

FIGS. 5-7 are cross sectional views showing the installation of two adjacent display modules 12A and 12B (having base plates 30A and 30B, respectively) into chassis 14, and the various forces applied to the installed display modules. In FIGS. 5-7, adjacent display modules 12A and 12B and base plates 30A and 30B each have the same structure as disclosed herein for display module 12 and base plate 30, and are simply labeled with “A” and “B” so they can be differentiated in the following description.

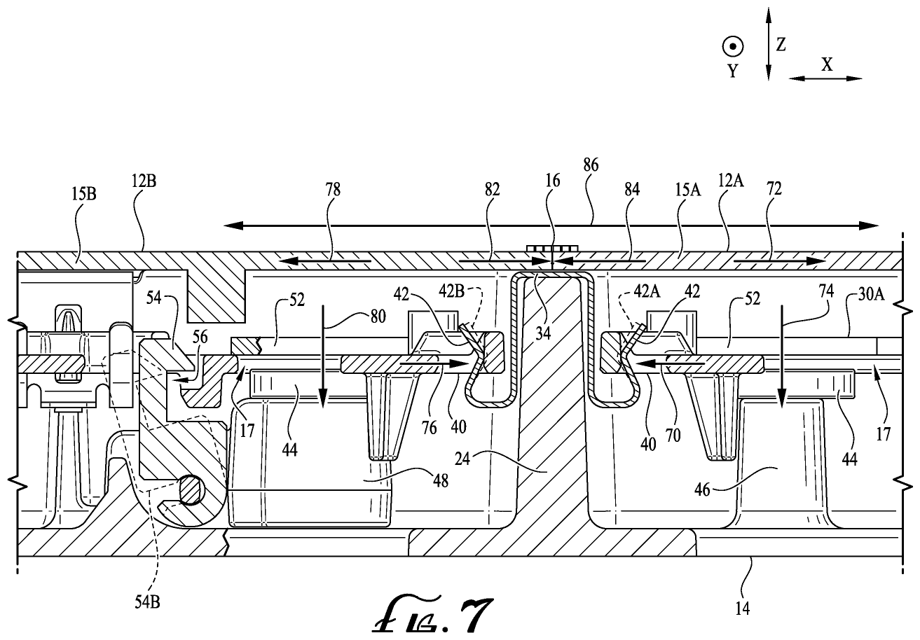

With reference to FIGS. 5-7, the first display module 12A and second display module 12B are installed on chassis 14. As shown by FIG. 7, during installation, retention hook 54 rotates to an unlatched position 54B and then rotates back to its resting position (illustrated as 54) within opening 56, thereby securing base plate 30B to chassis 14. Retention hook 54 may be magnetically attracted to magnetic element 44 to urge retention hook 54 to its resting position. To allow module 12B to be removed from chassis 14 for repair or replacement, or for other servicing of the display device 10, retention hook 54 can be magnetically actuated to position 54B by a magnet of a tool held in proximity to display module 12B. For example, the tool may be of the kind shown in FIGS. 4-6 of U.S. Pat. No. 10,495,255, assigned to the applicant, Planar Systems, Inc. Alternatively, retention hook 54 may be biased to its resting position using a spring, a magnetic element of the chassis 14 other than magnetic element 44 (e.g., another magnetic element positioned within the chassis), or some other force generating mechanism. Here, to remove module 12B, a tool that actuates retention hook 54 to position 54B by manipulating the spring, other magnetic element, or force generating mechanism may be used.

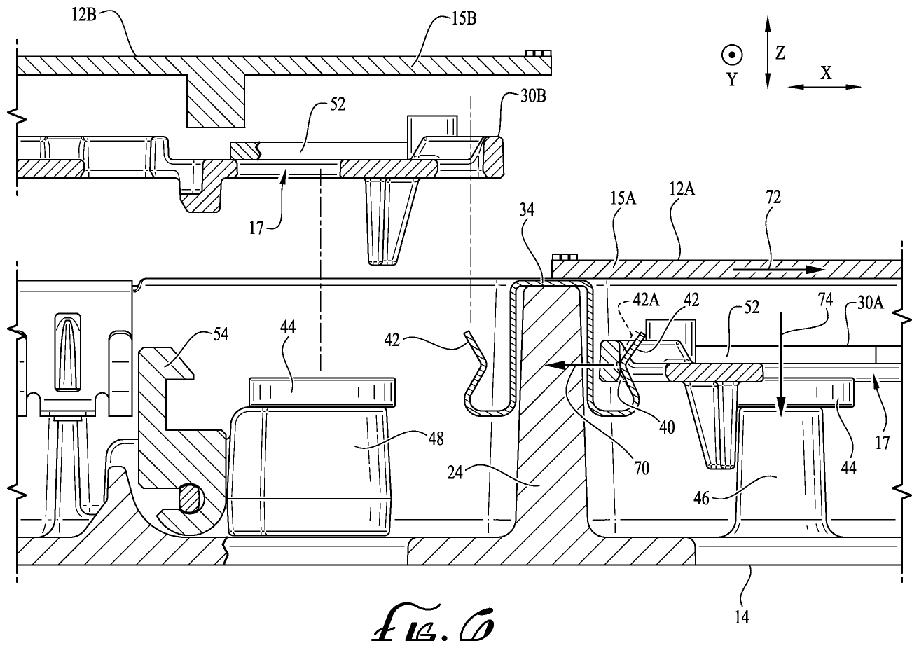

With reference to FIGS. 6 and 7, during installation, legs 42 of spring 34 engage the surrounding inner surface of openings 40 of base plate 30A and base plate 30B. As shown, legs 42 flex away from resting positions 42A and 42B (shown in dashed lines) when engaging the inner surface of the opening 40 in base plates 30A and 30B. Thus, when installed, legs 42 produce a force 70 pulling base plate 30A toward vertical rib 24 and a force 76 pulling base plate 30B toward vertical rib 24 and pulling display adjacent display modules 12A and 12B together so that outer perimeter edges of their respective tiles [15A] and [15B] are pressed into contact along seam 16. Forces 70 and 76 maintain alignment of display modules 12A and 12B by countering a force 86 produced by thermal expansion.

For example, with reference to FIGS. 4, 6, and 7, legs 42 of springs 32 retain the module 12 to chassis 14 and bias module 12 in a direction away from ribs 24, 26 (in the X or Y direction, parallel to module 12) which achieves a preload force on springs 34. With reference to FIGS. 6 and 7, the preload force allows the modules 12A and 12B to float in the X-Y direction relative to chassis 14, and accommodates thermal expansion and contraction of other modules 12 in the array. Thermal expansion (illustrated by arrows 86) tends to cause the seam 16 and adjacent modules 12A and 12B to move slightly, while the springs 32, 34 acting on adjacent modules 12A and 12B and other modules 12 oppose expansion-induced movement and apply biasing forces 82 and 84 on adjacent modules toward the expanding module. Conversely, if a module 12 contracts due to cooling, the biasing force of the springs 32 and 34 continue to bias all of the modules 12 toward each other allowing them to shift slightly in the X-Y direction to maintain the tight seams 16 between all modules 12.

Regarding springs 34 located on vertical ribs 24 and horizontal ribs 26 of chassis 14, after engaging base plate 30, the legs 42 of each spring 34 have a preload force applied to them due to the flexing of springs 32 as they engage openings 40. For example, when module 12 expands, producing a force against an adjacent module (12A or 12B), the legs 42 of springs 34 produce a force parallel to module 12 (in the X or Y direction), pushing module 12 toward the rib 24 and/or 26 where the spring is installed (and thereby toward adjacent module(s)). The biasing of springs 32 and 34 therefore maintains alignment of each display module 12 such that seams 16 between modules are reduced, even in the event of thermal expansion that may occur, for example, due to variations in power supplied to display modules during operation. Forces 74 and 80, which are magnetic attraction forces between magnetic elements 44 and magnetic element 52, also assist in maintaining the alignment of each module 12A and 12B within chassis 14. In the embodiment shown, magnetic elements 44 and 52 provide frictionless attraction in the Z direction that allow modules 12A and 12B to float in the X-Y plane relative to chassis 14. Forces 82 and 84 are module to module reactive forces that occur, and forces 72 and 78 are friction of display module 12A and display module 12B on the surface of vertical ribs 24 and other edges of chassis 14, including frame 22 and horizontal ribs 26. The Z plane of the display surface 18 of display device 10 is established by the collection of front-facing surfaces of perimeter frame 22 and ribs 24 and 26, which together form a datum for the modules 12 in the Z-direction. Rear surfaces of the display tiles 15A, 15B rests on the front surfaces of the frame 22 and ribs 24 and 26. In other embodiments, the Z plane of display device 10 may be set via one or more adjustable elements of the chassis, such as one or more screws, that alter the Z position of one or more modules 12 but still allows the module(s) to “float” in the X and Y directions.

As discussed, springs 32 and 34 bias adjacent modules 12 toward each other. In some embodiments, the biasing forces modules 12 toward the center or a central region of display device 10. In other embodiments, the springs 32 and 34 are tuned such that they bias adjacent modules together toward a particular corner or other region of display device 10. For example, each display module 12 may be acted on by springs 32 and/or 34 such that they are forced toward the top of display device 10 and toward the right side of display device 10 (i.e., toward the right-hand corner of device 10). With reference to FIG. 1, in some embodiments, display device 10 includes one or more springs 32 positioned on top edge 21, bottom edge 23, left edge 25, and right edge 27 of frame 22. In other embodiments, one or more springs 32 are positioned on one or a subset of top edge 21, bottom edge 23, left edge 25, and right edge 27; positioning springs 32 in this manner allows for biasing one or more display modules 12 toward the edge(s) having the spring(s) 32. For example, with reference to FIG. 1, by having one or more springs 32 positioned on top edge 21 and right edge 27, display modules 12 are biased toward top edge 21 and right edge 27 of frame 22 (e.g., the top right corner of display device 10).

In some embodiments, springs 32 and 34 are tuned such that their legs 42 exert the same or substantially the same spring force on display modules 12. In other embodiments, one or more of springs 32 and/or 34 are tuned such that their legs 42 exert different spring forces. In one example, springs 32 and/or 34 may apply a larger spring force on adjacent modules 12 in a first region of display device 10 relative to springs 32 and/or 34 of a second region of display device 10. For example, the first region may be the center or a central region of display device 10, and the second region may be a perimeter or surrounding region of display device 10. The larger spring force(s) more tightly forces adjacent modules toward each other, which may be beneficial when certain regions of display device 10 require less visibility of seams 16 relative to other regions. Display devices 10 with curved surfaces, and/or non-coplanar facets forming a curve, may benefit from having larger spring forces applied to the center or central regions of the display so that center modules more tightly coupled to each other and uniformity between different display modules 12 is maintained.

The embodiment shown in FIGS. 1-7 focuses on a display device 10 having a single chassis 14. However, in other embodiments, display devices may include multiple chassis 14 connected together.

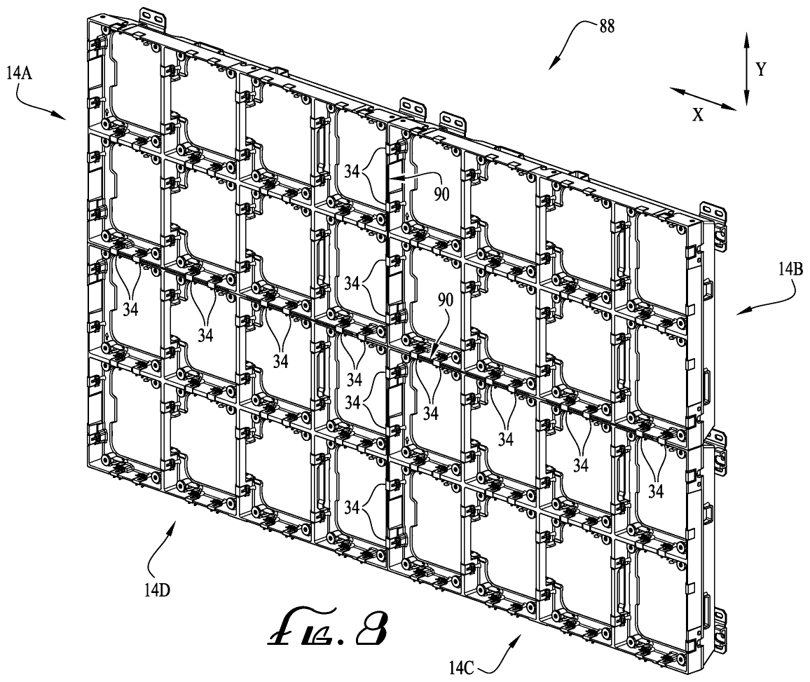

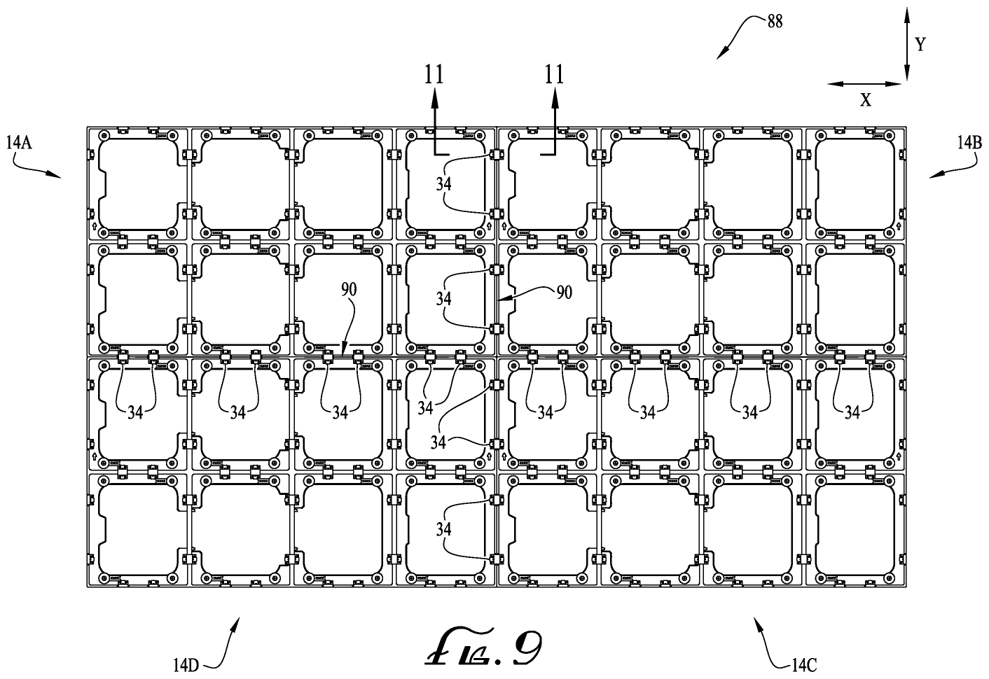

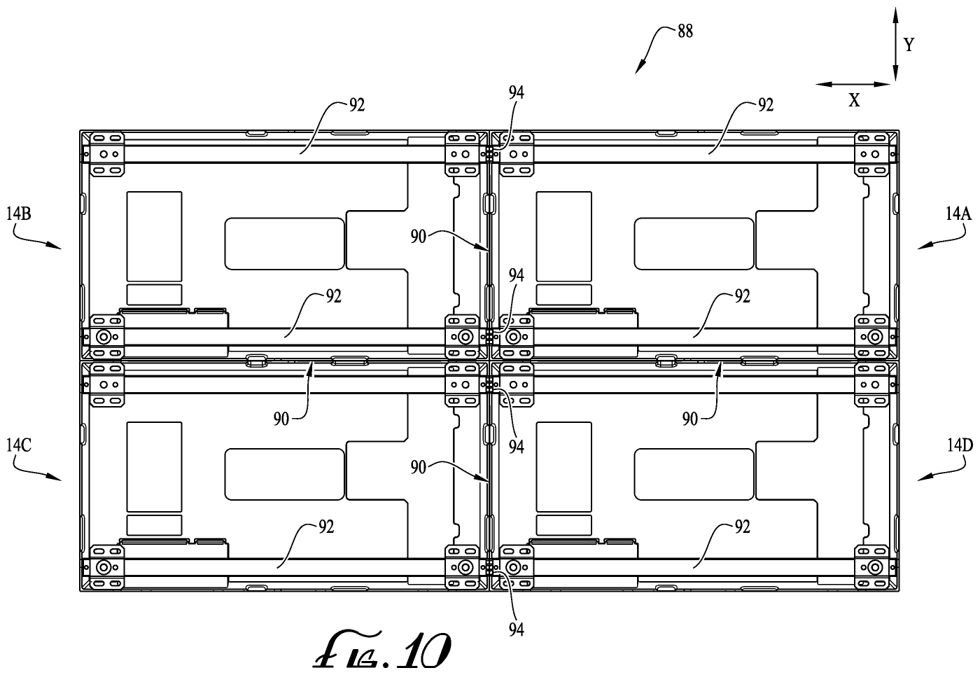

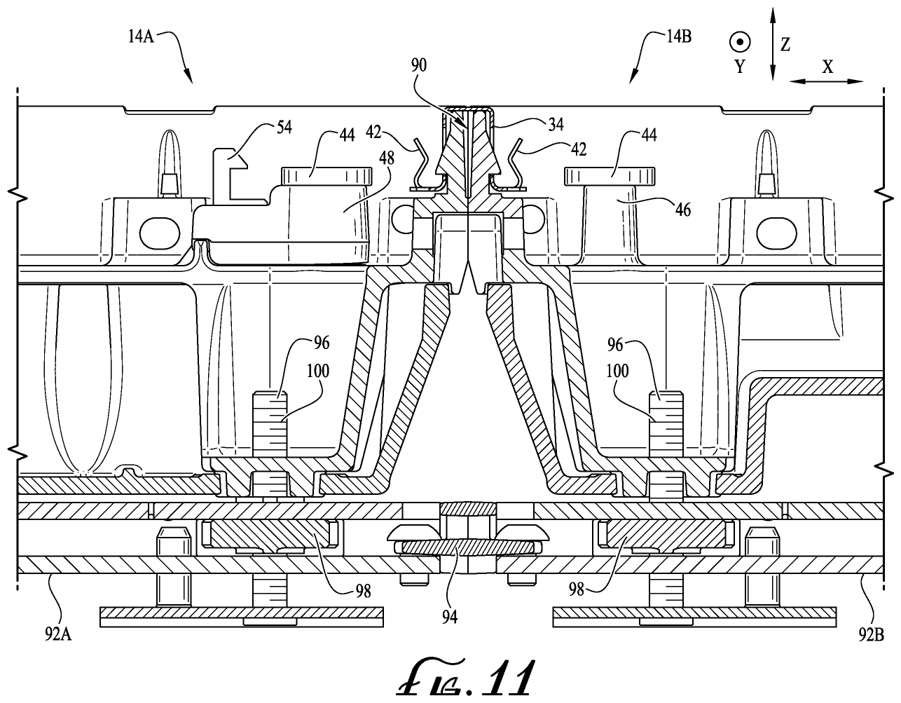

FIG. 8 shows an isometric front view of an electronic display device 88, formed by four chassis 14 (identified as 14A, 14B, 14C, and 14D), with display modules 12 removed. FIG. 9 shows a front view of electronic display device 88 formed by chassis 14 with display modules 12 removed. FIG. 10 shows a back view of electronic display device 88. Like display device 10, when display modules 12 are installed, each chassis 14 comprises an array of display modules 12, and display device 88 is a DV-LED display. FIG. 11 shows a cross sectional view taken alone line 11-11 of FIG. 9, showing two adjacent chassis 14A and 14B in which a double-sided spring 34 connects and straddles abutting portions of the perimeter frames 22 of the chassis 14A and 14B. Chassis 14A and 14B may alternatively be joined by other means.

With reference to FIGS. 8, 9, and 11, in the embodiment shown, each chassis 14 is configured to secure an array of eight display modules 12 in a two by four array of modules. However, a greater or lesser number of modules 12 may be secured to each chassis 14. Chassis 14A and 14B are secured to each other such that one or more visible seams 90 between each adjacent chassis 14 is minimized. Further, when installed, like for device 10, modules 12 of each chassis 14 are secured to each chassis 14 such that the visible seam between each adjacent module 12 is minimized (not shown in FIGS. 8-11). Chassis 14 may constitute a rigid frame in which display modules 12 are installed. In display device 88, one or more of the chassis 14 may have the same or a different number of cavities 28 and/or modules 12 compared to one or more other chassis 14; further, one or more cavities 28 of a chassis 14 may have different X, Y, and/or Z dimensions compared to one or more cavities 28 of one or more other chassis 14. With reference to FIG. 10, one or more support bars 92 or other mounting supports are secured to each chassis 14, and used to secure display device 88 to a surface (e.g., a wall) (not shown in FIGS. 8-11) where device 88 is mounted. With reference to FIG. 11, multiple support bars 92A and 92B may be coupled together by plugs or braces 94 to provide a longer compound bar. For example, braces 94 are made of plastic or any other rigid material, and may be rigid spacers configured to help positioning of adjacent chassis 14 within the array of chassis. Chassis 14A and 14B are located on threaded pins or bolts 96 (e.g., having thread 100) projecting from support bars 92. Grommets or nuts 98 (e.g., thumb nuts) surround each bolt 96 within support bars 92 and provide a clamping force that holds the chassis and support bars together. In some embodiments, nuts/grommets 98 are magnetic and attract support bars 92 to chassis 14, which provides further securing of chassis 14 to support bars 92. In one example, one or more bolts 96 may be secured by nuts 98. By adjusting each nut 98 on a respective bolt 96 (e.g., rotating clockwise or counter-clockwise along thread 100), the positioning of support bar 92 in the Z direction is adjusted. This allows for tuning each support bar 92 so they are planar with each other. For example, support bars 92 may be mounted to a surface, without chassis 14. One or more chassis 14 may then be installed on the support bars 92 using bolts 96, secured by nuts 98. Support bars 92 may then be tuned in the Z direction by adjusting nuts 98

Embodiments of this disclosure are usable in any type of panel element array, in addition to electronic image or video display arrays, including those where space or access to panels may be limited, and changes in the X, Y, and/or Z positions need to be maintained over a range of ambient conditions. For example, in building elements (e.g., frame of a building, sheeting/siding that covers interior and/or exterior walls, etc.), where growth or movement are to be expected (e.g., normal element exposure, high rise swaying, earthquake, etc.), the concepts of this disclosure where adjacent objects are biased together or to a particular region may be employed.

For example, instead of using caulk to bind adjacent siding panels located on the exterior of a building, adjacent panels may be biased together using the concepts of this disclosure, which would accommodate growth or movement of the panels, yet maintain seal(s) between panels. In another example, in lieu of using mortar to seal between furnace or kiln tiles, adjacent tiles may be biased together using the concepts of this disclosure. This may allow for easier product shipping and/or assembly without relying on specialized skill or tradesman.

It will be obvious to those having skill in the art that many changes may be made to the details of the above-described embodiments without departing from the underlying principles of the invention. The scope of the present invention should, therefore, be determined only by the following claims.

1. An electronic display device, comprising:
a chassis including an array of cavities and multiple ribs bordering each of the cavities, each of the ribs including a front surface;
an array of display modules, each display module disposed at least partly in one of the cavities and supported on the front surfaces of the ribs bordering said cavity so as to establish a Z position of the display module in a Cartesian coordinate system, the array of display modules establishing a forward-facing display surface that extends in X and Y directions of the Cartesian coordinate system, adjacent pairs of the display modules contacting each other along abutting edges of the display modules; and
a plurality of springs supported by the chassis and disposed behind the display surface, each of the springs being flexible away from a resting position to generate a spring force in a direction along the display surface, each display module being engaged by a subset of the plurality of springs so as to bias the display module toward an adjacent one of the display modules and press together the abutting edges thereof, thereby reducing seams between adjacent pairs of the display modules throughout the display device, the springs being resilient to accommodate thermal expansion of the display modules.

2. The electronic display device of claim 1, wherein the chassis is formed of unitary rigid one-piece construction.

3. The electronic display device of claim 1, further comprising a plurality of magnetic elements attracting the display modules toward the chassis in a Z direction of the Cartesian coordinate system.

4. The electronic display device of claim 1, wherein each of the springs bears against one of the ribs and each rib has at least one spring that bears against said rib.

5. The electronic display device of claim 1, wherein each of the springs is attached to one of the ribs.

6. The electronic display device of claim 5, wherein at least some of the springs are double-sided springs, each side having a leg, one of the legs extending into a first one of the cavities on a first side of the rib to which it is attached, and the other of the legs extending into a second one of the cavities on a second side of said rib.

7. The electronic display device of claim 1, wherein each display module includes openings that receive a leg of least one of the springs when the display module is installed onto the chassis and to preload the leg, the springs pulling adjacent pairs of the display modules together.

8. The electronic display device of claim 1, wherein each of the display modules includes a base plate and one or more display tiles mounted on the base plate, the display tiles having opposite front and rear surfaces, and the front surfaces of the display tiles forming the display surface.

9. The electronic display device of claim 8, wherein rear surfaces of the display tiles opposite the display surface rest on the front surfaces of the ribs, and the display tiles have outer perimeter edges forming the adjacent edges of the display modules.

10. The electronic display device of claim 1, wherein the display modules are removable from the chassis for servicing without accessing a rear or sides of the electronic display device.

11. The electronic display device of claim 1, wherein the chassis further includes retention hooks positioned in each cavity and the retention hooks are configured to prevent the display modules from being accidentally removed from the chassis.

12. The electronic display device of claim 11, wherein each of the display hooks is magnetically actuatable by holding a magnet in front of the display surface.

13. The electronic display device of claim 1, further comprising one or more additional chassis connected to the chassis.

14. The electronic display device of claim 13, wherein at least one of the springs is connected to a perimeter frame of the chassis and to a perimeter frame of the additional chassis.

15. The electronic display device of claim 13, wherein the chassis is mounted on a screw for adjusting a position of the chassis in the Z direction relative to the additional chassis.

16. A system for mounting and positioning multiple panels in side-by-side relation, comprising:
a chassis including an array of cavities and multiple ribs bordering each of the cavities, each of the ribs including a front surface;
an array of panels, each panel supported on the front surfaces of the ribs bordering said cavity so as to establish a Z position of the panel in a Cartesian coordinate system, the array of panels establishing an outer surface that extends in X and Y directions of the Cartesian coordinate system, adjacent pairs of the panels contacting each other along abutting edges of the panels; and
a plurality of springs supported by the chassis and disposed behind the panels, each of the springs being flexible away from a resting position to generate a spring force in a direction along the outer surface, each panel being engaged by a subset of the plurality of springs so as to bias the panel toward an adjacent one of the panels and to press together the abutting edges thereof, thereby reducing seams between adjacent pairs of the panels throughout the system, the springs being resilient to accommodate thermal expansion of the panels.

17. The system of claim 16, wherein the chassis is formed of unitary rigid one-piece construction.

18. The system of claim 16, further comprising a plurality of magnetic elements attracting the panels toward the chassis in a Z direction of the Cartesian coordinate system.

19. The system of claim 16, wherein each of the springs bears against one of the ribs and each rib has at least one spring that bears against said rib.

20. The system of claim 16, wherein each of the springs is attached to one of the ribs.

21-26. (canceled)
